(19) United States
(12) Patent Application Publication
(10) Pub. No.: US 2004/0103583 A1
(43) Pub. Date: Jun. 3, 2004

(54) Hanging garden planter

(76) Inventors: Martin Woergaard Eriksen, Copenhagen (DK); Isabel Marta Umana, Arlington, TX (US)

Correspondence Address: MARTIN ERIKSEN, NORREBROGADE 3B, 3TH, 2200 COPENHAGEN N, DK

(21) Appl. No.: 10/308,526

(22) Filed: Dec. 3, 2002

(51) Int. Cl. A47G 7/02; A01G 9/02

(52) U.S. Cl. 47/67

(57) ABSTRACT

A new, simplified, versatile, portable, self-contained hanging garden structure for growing plants, and its production method. An elongated, tubular-shaped sleeve open at one end and sealed at the other to form a watertight system, with reinforced holes placed in the top to support a hanger apparatus. Said sleeve is filled with plant growing material, having a display platform in which plants may grow and extend out from pierced slots. A cone-shaped water distributor is placed in the center of said sleeve, flush with the top, the center being void of growing material, and the cone using gravity to allow even water distribution through orifices cut into the sides of the sleeve. A hanger apparatus is attached to the reinforced holes for hanging the garden structure on an above ground structure.

### TECHNICAL FIELD

The invention relates generally to the display and cultivation of plants and, more particularly, to a new system and method for displaying and cultivating plants by suspending them.

### BACKGROUND

In our modern society, a premium has been placed on yard or gardening space. Plants are attractive to have in the home, patio or balcony, and the experience of such allows the plant owner or gardener a means to enjoy nature and gain the benefits of relaxation. Many people enjoy the advantages of a garden, but do not have the time, space, energy or skills to cultivate it successfully.

There is a need for a garden planter which is self-contained, makes use of minimum growing space, is easy to produce and use, comprises a minimum number of parts, is readily disposed of, is portable, and requires a minimum knowledge, skills, and effort on the part of consumers to easily enjoy the benefits of a garden year round.

There is also a need for a plant watering device which automatically distributes water to all plants evenly, is self-measuring to nourish the plants without over-watering, requires a minimum of parts or mechanical devices, and is easy for gardeners to use in caring for the healthy growth of their plants.

Gardeners who desire a unique, creative, flexible and portable garden need a planter which can be used as a novelty item, or can be readily converted for many applications.

Many gardeners love gardening because they enjoy the positive feelings associated with having a creative hobby that releases stress, nurtures a sense of accomplishment and provides a connection with the earth. Stores specializing in hobby and artistic projects are very popular and profitable now. They provide the hobby enthusiast and novice artist with an outlet for their creativity. There is a need for an easy-to-assemble hobby kit that includes all the basic garden planter materials, as well as additional ornamentation and decoration. This will serve to satisfy a gardener's need to connect with the earth, as well as their desire to be creative and imaginative.

For the health conscious consumer looking for an easy, portable garden, there is a need for a planter that besides growing beautiful plants and flowers is also practical in growing organic herbs that are used for seasoning foods.

There is a need for a production method in a garden planter which is economical, flexible, easy to produce, grow and display, and isn't difficult to assemble or maintain for either the novice, the expert gardener or nursery professional.

Our society demands fast, efficient, and easy-to-use devices which can provide these benefits in a short amount of time with limited space.

Attempts to develop a vertical planting device or apparatus have failed to meet the aforementioned needs. By way of example, reference is now made to U.S. Pat. Nos. 5,555,676; 5,381,625; and 5,363,594. These planter systems have been proposed for the purpose of providing a garden atmosphere with a limited amount of space.

Referencing U.S. Pat. No. 5,555,676—Lund discloses a hollow column planted vertically on a water reservoir, having planting ports in a circumference around the wall of the hollow column to provide access for plants to grow out the port openings. It also provides a water distribution system, moisture sensors and an optional timer driven water pump to deliver water from the reservoir to the water distribution system.

Referencing U.S. Pat. No. 5,381,625—Wente discloses an upright, elongated, cylindrically-shaped flowering planter of an opaque synthetic plastic material. The planter contains a cup shaped bottom portion and hangs from an above-ground support. Openings extend circumferentially from the hollow sleeve for plants to extend or grow from the slots. A cylindrical watering tube is mounted within the hollow sleeve enabling water to be conveyed to the plant root structure at each of the keyhole shaped slots.

Referencing U.S. Pat. No. 5,363,594—Davis discloses a vertical garden growth container comprising a series of vertical, self contained, individual plant or growing containers, containing growth orifices with aeration holes located on the exterior of a hexagonal shaped stock. Plants grow from the orifices nourished by a recyclable irrigation system supporting vertical growth of harvest products.

The aforementioned patented planter and watering devices have a number of drawbacks, such as, for example, they require a relatively large number of extra mechanical parts, systems, and pumps which must be used to assemble the garden and to maintain the health of the plants. The complexity of a gardening method which requires many parts for assembly and maintenance does not meet a modern gardener's desire for a simple and easy-to-use garden planter. Many gardeners are not mechanically inclined and would find the use of such watering devices and pumps clumsy, as well as finding themselves unable to make repairs if mechanical failure were present, creating frustration in the gardener.

The problem with vertical planting devices concerns the plants being inserted around a vertical structure, creating an unnatural situation for plant growth. Most plants naturally grow upwards towards the light from a horizontal earth position. This encourages solid root and plant structure growth.

Another problem with vertical planting devices concerns the amount of light that reaches each plant. These planters must be continually turned so that all plants receive adequate sunlight for growth. The planters that are fixed in one position do not have the flexibility of movement. The gardener must remember to use extra vigilance to manually turn the planters to ensure all plants are adequately provided with the light necessary for healthy growth or make sure the fixed planter is positioned in such a way that the light requirements are met for all the plants.

Yet another problem with these vertical planting devices is that, while they may be functional, they do not meet the gardener's requirements for simplicity, flexibility, or novelty in their use.

There is a need for a vertical planter apparatus which provides a solution to these problems and meets the gardener's needs as well as resolving the problems with other vertical planting devices.

### SUMMARY

The present invention, accordingly, provides an attractive, versatile, portable and simplified garden structure and method of producing the same. It is a new planter apparatus and method wherein the planting medium for a plurality of plants is grown and contained in a vertical sleeve. A water distributor is placed in the sleeve that disburses water and/or nutrients in a substantially balanced manner to the entire hanging garden planter. Slots or openings in the front of the sleeve provide a display platform for the insertion of plants which allows them to grow out from the hanging garden planter. A backside of the hanging garden planter rests against a vertical or above ground structure, suspended by a rope or other suitable hanger apparatus attached to reinforced holes at the top of the sleeve.

A preferred method of production involves the insertion of the plant growing material and the water distributor within the sleeve as it lies horizontally on a flat surface. The hanger apparatus is securely attached to the reinforced holes on the sleeve. Plants are inserted within the slots or openings and a watering system is provided to the plants while they grow naturally towards the light. Once the root system is established, the hanging garden planter is ready to be displayed on a vertical or above ground structure. Use of the water distributor then becomes the means for disbursing water and/or nutrients in a substantially balanced manner throughout the hanging garden planter.

A distinguishing feature of this invention is the flexibility it provides for many creative and novel uses, not limited to the disclosure provided herein. This novelty of use meets a need for versatility and simplicity which is in high demand in our society. Other objects, features and advantages of the present invention will become apparent from a consideration of the following detailed description.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 and 2 are elevation views of a hanging garden planter suspended from a wall of a house in accordance with features of the present invention;

FIG. 3 is an elevation view of the front of the sleeve of the hanging garden planter of FIG. 1;

FIG. 4 is an elevation view of the front of the sleeve with an attached hanger apparatus of the hanging garden planter of FIG. 1;

FIG. 5 depicts details of the hanger apparatus used in connection with the hanging garden planter of FIG. 1;

FIG. 6 depicts details of a water distributor used in connection with the hanging garden planter of FIG. 1;

FIG. 7 shows a cross-sectional view of the sleeve and water distributor of the hanging garden planter of FIG. 1;

FIG. 8 depicts the top view of a substantially filled sleeve with the front, or display platform, facing forward in connection with the hanging garden planter of FIG. 1;

FIG. 9 shows the top view of a substantially filled sleeve with the plain backside facing forward in connection with the hanging garden planter of FIG. 1; and

FIG. 10 illustrates an alternate embodiment of the present invention in which the hanging garden planter of FIG. 1 is positioned in a horizontal position.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the cultivation and display of plants and the like have been omitted inasmuch as such details are not considered necessary to obtain a complete understanding of the present invention, and are considered to be within the skills of persons of ordinary skill in the relevant art.

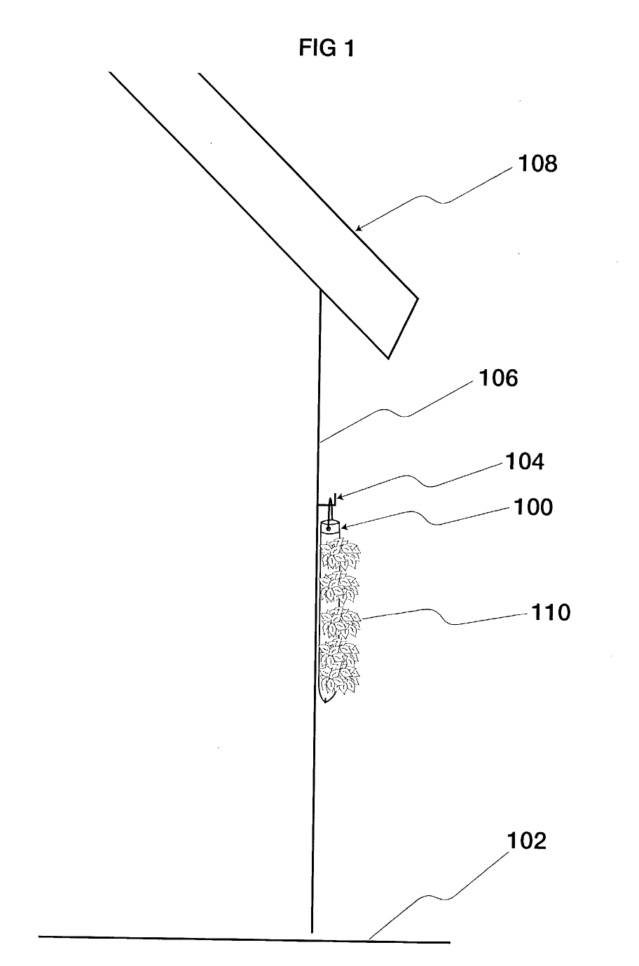

Referring to FIGS. 1 and 2 of the drawings, the reference numeral 100 generally designates a hanging garden planter embodying features of the present invention, wherein the garden is suspended above ground 102 from a hook 104 extending from a wall 106 of a dwelling 108 such as a house. The system 100 is a versatile, portable and flexible garden structure. It also comprises a combination of efficient production methods and provides a very easy, economical and flexible way to grow and display plants, as will be appreciated from a reading of the following. The hanging garden planter 100 is a new planter apparatus and method wherein a plurality of plants are grown and protrude from a vertical sleeve that allows the functional and attractive display of plants or flowers 110.

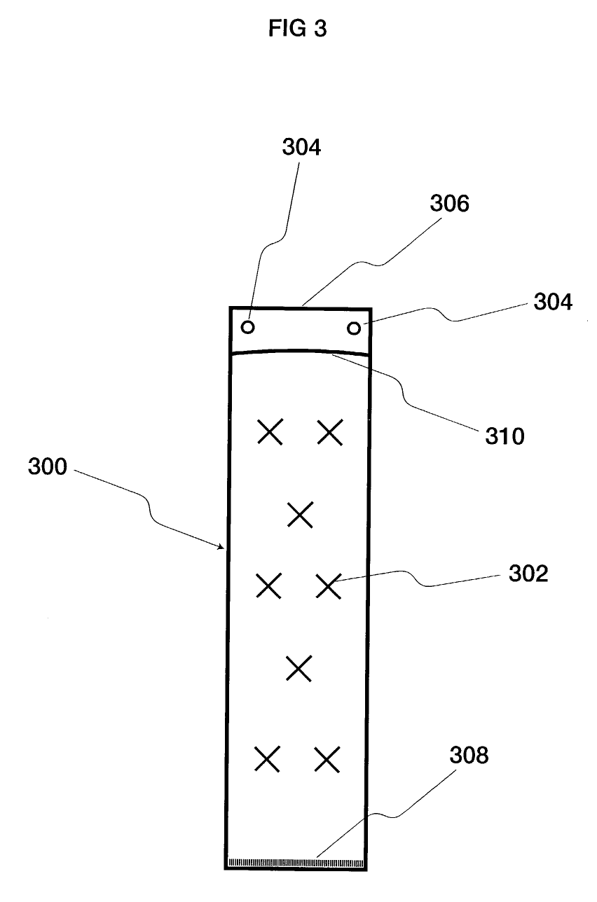

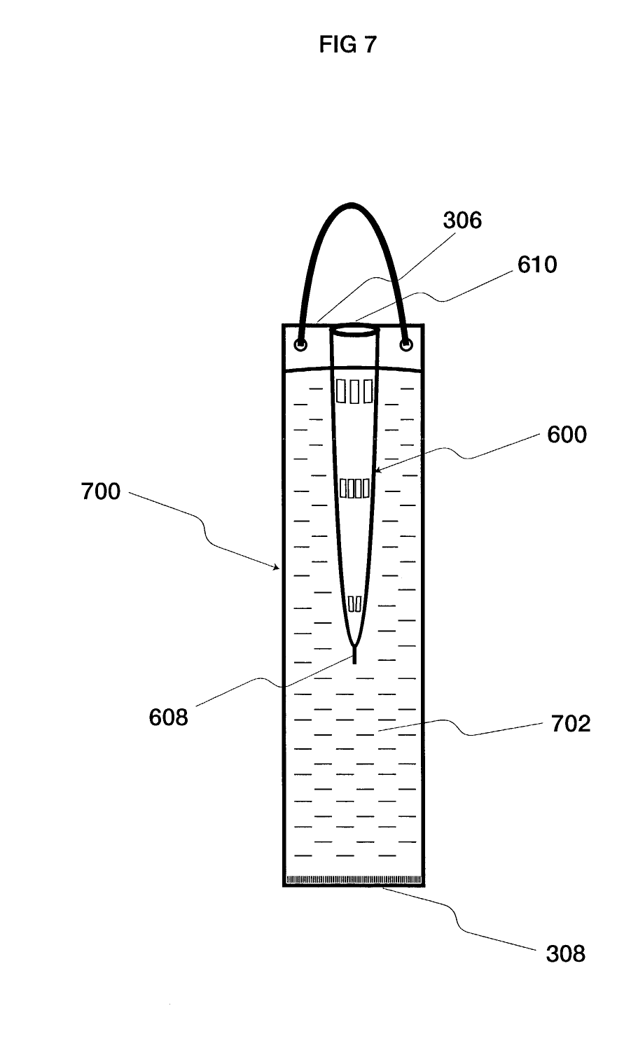

As shown in FIG. 4 and FIG. 7, the hanging garden planter includes: a) a water tight sleeve 300 pierced with open slots 302 on the front side which provides a display platform where the plants will grow from, and having a plain backside; b) a cone-shaped water distributor 600 and; c) a suitable hanger apparatus 400 attached to the reinforced holes 304 at the top of the sleeve 306. The hanging garden planter 100 may be suspended from a hook 104 on any vertical surface such as a wall 106 or on an above ground structure. With gravity and the weight of the invention itself, it will maintain a vertical and stable position. Additionally, this detailed description includes the highly simplified, practical and efficient production method for this hanging garden planter.

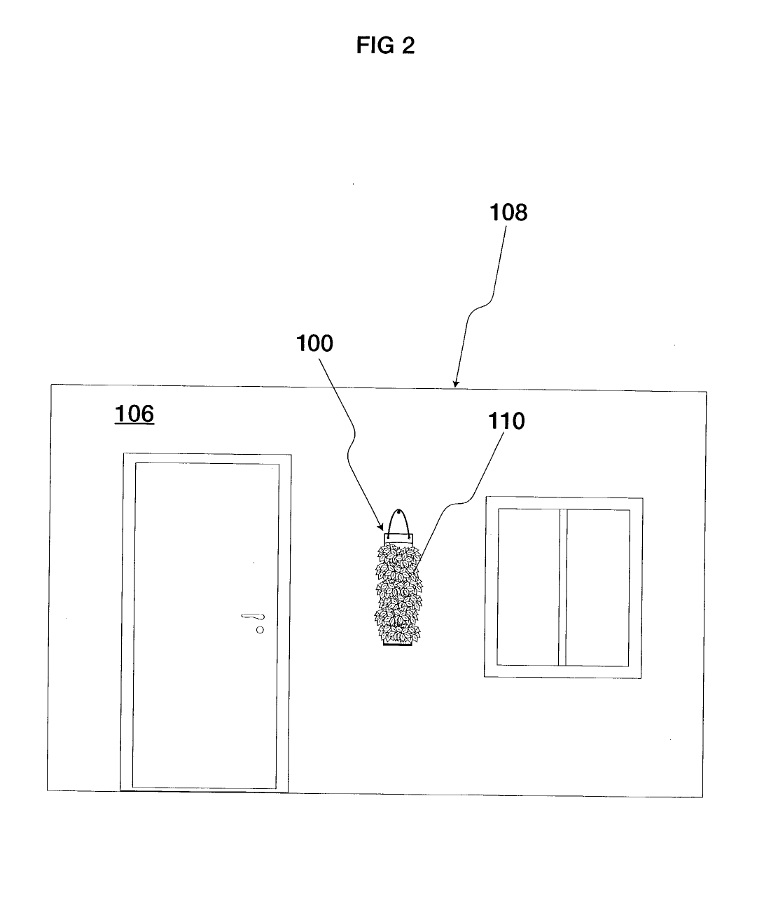

Referring to FIG. 3, the sleeve 300 may be produced from a number of different materials of various dimensions. It has been found that approximate proportions of the folded 310 sleeve of one unit in width by two and one-half units in length, as displayed in FIG. 3, work well for many purposes. In this example, the approximate proportions of the sleeve prior to folding the top edge is one unit in width by three units in length. It has been found that preferable materials such as polyvinyl chloride (PVC), other plastic materials, and the like, work very well. All colors for the sleeve have been found to work well. However, to protect the roots of the plants from light, darker colors are preferred. Furthermore, darker more neutral colors such as dark green will often blend in with the leaves of the plants or even the background on which it hangs, thereby full attention is placed on the plants themselves. The thickness of the sleeve material must be such that its strength and durability will support and maintain the hanging wall plants. For PVC or plastic sleeve material, the thickness should preferably be at least 0.6 mm. The sleeve is sealed, preferably via heat welded, in one end, the bottom 308, to make it water tight. The other end, the top 306, is left open. If two separate longitudinal pieces of PVC or plastic are used, then the sides as well as the bottom of the sleeve must be sealed (e.g., preferably heat welded) together to form the sleeve configuration. The tubular sleeve 300 as suggested in this invention is preferable to heat welding two longitudinal pieces of material together for several reasons: for greater overall strength and stability, and it is economical and practical.

From the top 306 of the sleeve 300, the plastic material is preferably folded over twice or least one and a half times, as depicted by the reference numeral 310. The folds 310 as depicted in FIG. 3 and FIG. 4, provide a reinforced and strong base for two holes 304 used for the attachments of the hanger apparatus 400. They also reinforce the strength of the upper part of the sleeve so that the hanger can support the weight of the hanging garden planter 100 as well as the downward pull of gravity. Alternatively, it is also possible to use only one fold with this invention.

Two holes 304, one at each side of the sleeve 300, are made through the thickness in the material and reinforced. The reinforcement is made by attaching a conventional metal ring or grummet (not detailed). These rings have been found to work well, but other materials may be used as well. It has been found that a diameter of 1.5 cm for the hole works well. The dimensions of the hole and metal ring may be changed according to the material used for the hanger apparatus, as well as for the dimensions chosen for the sleeve itself.

Referring to FIG. 3, the front side of the sleeve 300 provides a display platform for the plants and will have a number of symmetrically placed openings or slots 302, long enough so the plant can be inserted therein. The sleeve can be pierced with any sharp tool or instrument that is engineered or found in local hardware stores that can make symmetrical cuts or slots through the sleeve. It is also possible to purchase the sleeve material with the openings or slots pre-cut into the sleeve by a manufacturer. Any number of openings or slots may be made to accommodate the growing needs of the plants and to provide fullness to the visual quality of the hanging garden planter. It has been found that a number of openings or slots between three and eight work well depending on the type of plants to be used in the hanging garden planter 100 and the configuration of the sleeve.

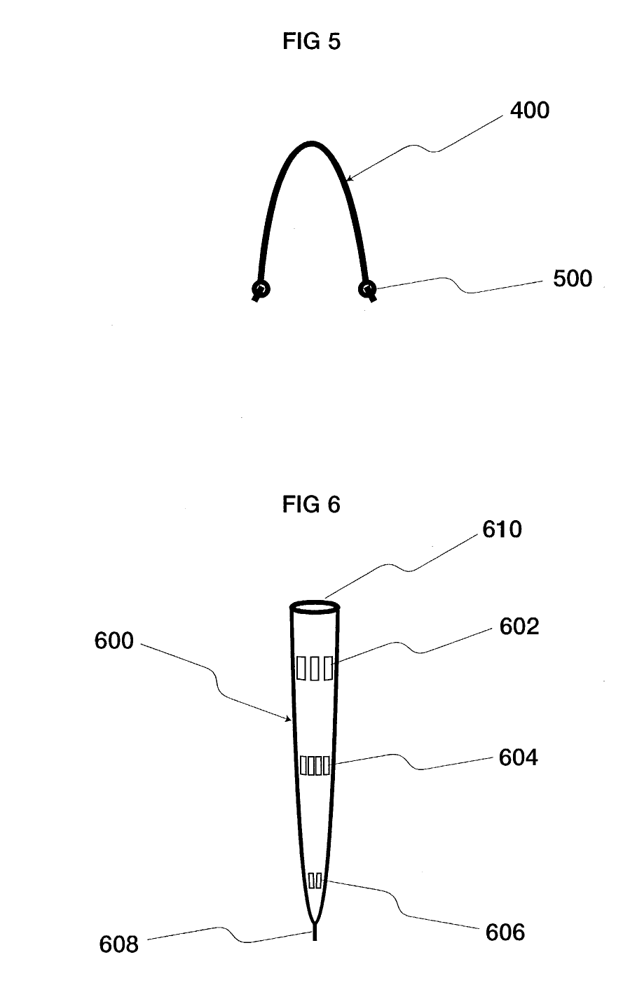

Referring to FIG. 6, the cone-shaped water distributor 600 provides an efficient and unique water and/or nutrient distribution system allowing the roots to be evenly nourished, using gravity and the unique design of the water distributor. The water distributor is preferably fabricated from PVC or other plastic material. This material needs to be of sufficient thickness to provide durability, strength, stability and is also light weight. Other materials such as steel or aluminum may be used as well. As viewed in FIG. 6, the water distributor has a larger open end at the top 610 and a smaller, elongated closed tip 608 at the bottom.

There are preferably three levels of specialized watering orifices 602, 604 and 606 on the sides of the water distributor 600 that are used to disperse the water. It is the placement and size of the orifices 602, 604 and 606 that uniquely ensure the even distribution of water to the roots. As shown in FIG. 6, the orifices are preferably square and/or rectangular shaped openings, but other shapes of the orifices may be used.

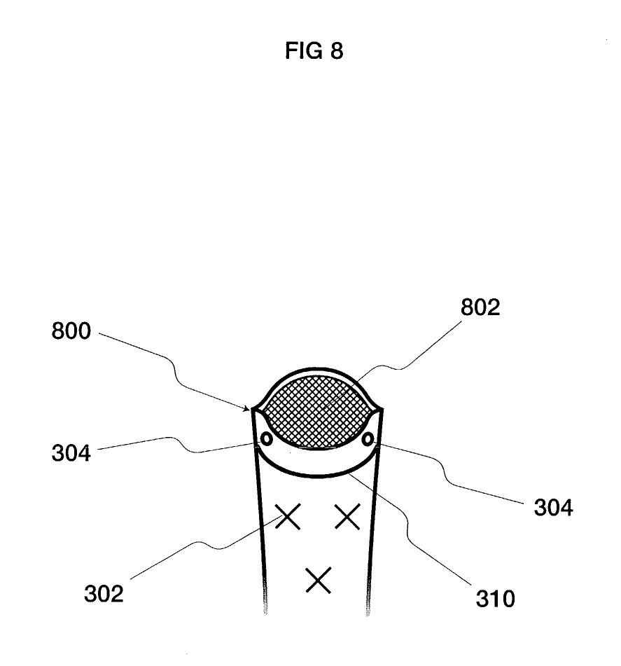

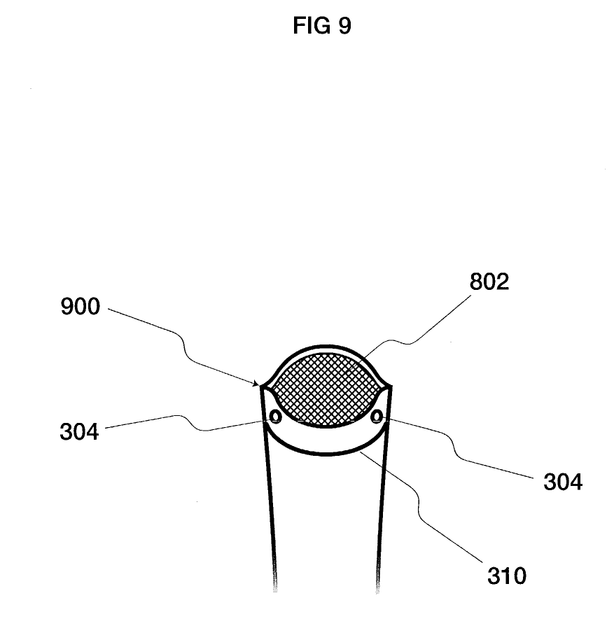

FIG. 7 is a vertical cross sectional view of the sleeve 700 and water distributor 600 of the hanging garden planter 100 found in FIG. 1 and FIG. 2. Soil or other plant growing material 702 is inserted into the sleeve from the open end 306. As is shown in the top view of a substantially filled sleeve of FIG. 8 and FIG. 9, the amount of plant filler material 802 used to fill the sleeve should preferably be adequate so that the form of the sleeve will attain a firm, oval, longitudinal shape, evenly filled from the top open end of the sleeve to the bottom sealed end. The oval shape of the adequately filled sleeve allows for a front 800 display platform where the plants will grow and protrude from the openings or slots 302, and a plain back side 900. The back side 900 of the filled sleeve is the side that will rest against a vertical surface such as a wall or other above ground structure. Because the back side of the filled sleeve of the hanging garden planter 100 may rest against an above ground structure or a wall 106, it will naturally conform to a more flat shape, while the front of the sleeve will maintain a more rounded shape.

Referring to FIG. 7, the water distributor 600 is preferably inserted into the center of the plant growing material 702 in the sleeve until the top 610 part of the water distributor is flush with the open end of the sleeve 306 ensuring the center of the water distributor does not fill with the growing material as well. The closed tip 608 of the water distributor points towards the bottom of the sleeve and the larger open end 610 is positioned at about the top of the sleeve 306. The elongated tip 608 at the bottom of the cone simply facilitates the easy insertion of the cone through the plant growing material 702 which fills the sleeve 700. The efficiency and effectiveness of the water distributor is not compromised if it does not contain an elongated tip. As is shown in FIG. 7, it has been found that the length of the water distributor 600 of a little more than half the length of the sleeve 700 and the diameter of the top part of the water distributor 610 of one quarter the diameter of the sleeve itself, is preferable. The length, diameter and the orifices of the water distributor all work together to assure the flow of water to the plants is equally distributed from the top to the bottom of the sleeve. It should be noted that this water distribution system only serves as the method of disbursing water and/or nutrients when the sleeve is hanging in an upright, vertical position, as the power of gravity serves as part of the hanging garden planter's unique watering system.

When it is time to provide water and/or nutrients to the hanging garden planter, it is preferable to apply only enough water until the level reaches the top 610 of the water distributor 600. Any excess water and/or nutrients added or on a too frequent basis will create sogginess at the base of the sleeve and possibly cause damage to the roots of the plants.

As is shown in FIG. 4, a hanger apparatus 400 is attached to the reinforced holes 304 in the top 306 of the sleeve 300. The hanger apparatus may be made of any material, but preferably a material such as rope, and the like, made from natural materials. Other materials of choice include plastic or PVC, metal chain, wire, or other rope hangers or the like made from synthetic materials like polyester.

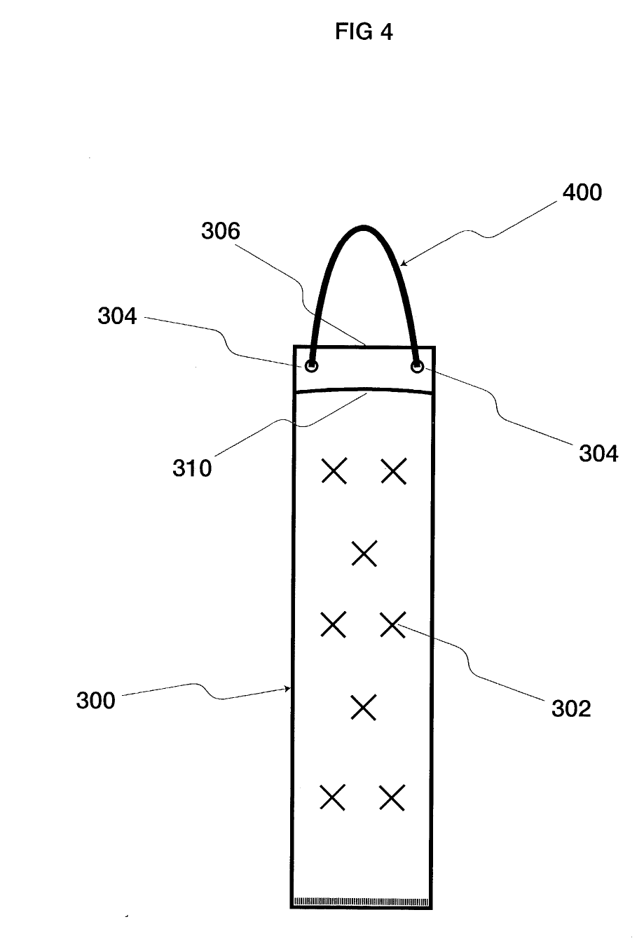

All of the materials for the hanger apparatus 400 should be strong enough to support the weight of the hanging garden planter 100 for an extended period of time when hung on a vertical or above ground surface. If rope is used as the hanger apparatus, as depicted in FIG. 5, it has been found that after the rope is inserted through each reinforced hole 304 in the sleeve 300, a knot 500 at each end of the rope will hold the hanger apparatus in position. In this method of attaching the hanger apparatus, it has been found that the thickness of the rope must be such that after the knot has been tied, it will not slip through the reinforced holes in the sleeve. The knot should be tight enough that it doesn't loosen, even after an extended time period. Depending on the type of material used for the rope, the knot may be glued with a water and weather resistant glue so as to secure the conformity of the knot. In the case of the use of other hanging materials, they should also be securely attached to the reinforcement rings 304 so the hanging garden planter does not fall from its hanging position.

The following description provides the preferable production method for assembling a hanging garden planter 100 using the sleeve, water distributor, hanger apparatus, and living plants, seeds or bulbs. It is understood that other methods can be employed to create the hanging garden planter that does not affect the essential nature of the invention. Depending on whether the hanging garden planter is assembled from a kit, for decorative uses with filler material and artificial plants, with different decorations or ornamentation, to facilitate a hanging garden planter with plants growing circumferentially around the sleeve, or using a simpler system without a water distributor, modifications to the production method may be necessary or desirable.

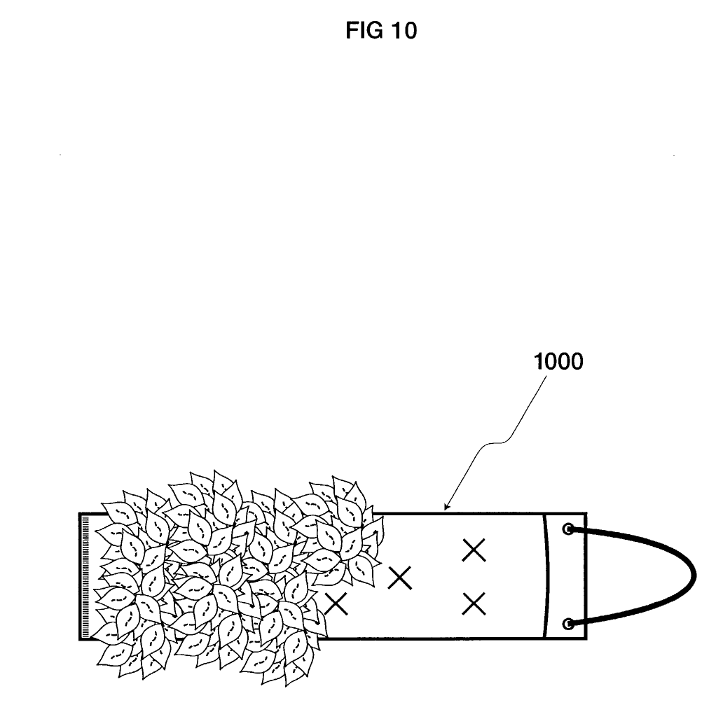

During the assembly and construction phase of production where the sleeve 700 is filled with plant growing material, the water distributor 600 is inserted, the openings or slots 302 are cut into the sleeve, and the plant roots, seeds or bulbs are inserted, it is preferable to lay the sleeve of the hanging garden planter 1000 on its plain backside in a horizontal position as is shown in FIG. 10, and placed on a flat horizontal surface such as a table or the ground (not shown). This horizontal position is advantageous during the growing and maturing phase of the plants for a number of reasons. One, the general handling of the hanging garden planter is easier, more stable and it allows for flexibility and creativity. Two, when the chosen plants are to be inserted in the sleeve, they can be pressed in a downward motion through the pierced holes into the plant growing material in the sleeve. Three, this position is preferable for the rooting and establishment of the growing plants as they will naturally grow upwards towards the light. This horizontal position also works well if decorations, ornamentation or different sleeve coverings are desired, as they can easily be inserted, glued or placed on the sleeve. In this position, the hanger apparatus 400 and/or the plant care instruction tag can be easily attached to the sleeve 300 through the reinforced holes.

Any series of plants such as impatiens, herbs, petunias, small ferns, lobelia, verbena, ivy, and the like, are suitable to be planted within the hanging garden planter 100.

During the subsequent production phase where the plants are establishing firm root systems, they are preferably watered using means other than the water distributor 600. It has been found that a water supply or hose to each plant in each slot or opening 302 is preferable. There are already well-established watering systems that will accomplish this. Alternately, they can be watered with a conventional water hose used for watering plants or with other watering means. The time required for growing the plants in this production phase will vary depending on the choice of plants, season and growth conditions.

When the plants are established and the roots firmly embedded in the plant growing material, the hanging garden planter 100 is ready to be placed in an upright position. Once it is in an upright position, the water distributor 600 becomes the preferred method for distributing water and/or nutrients in an evenly balanced manner throughout the sleeve. When the water and/or nutrients are poured to the brim of the water distributor, its unique design which includes the incorporation of the specialized orifices 602, 604, 606 on the side of the water distributor as displayed in FIG. 6, the size and placement of the water distributor 600 in the sleeve 700 as in FIG. 7, and the utilization of gravity, this essentially creates a new method of metering the correct amount of water in a safe, easy and efficient manner. The unique design and qualities of the water distributor functioning within the hanging garden planter also prevents over-watering which could damage the plant's root system. This is a great advantage for the gardener who does not necessarily have the knowledge of a trained professional to supply the correct amount of water for optimum plant growth and health. This new, safe and easy way of maintaining the health and growth of the plants adds desirable qualities to the product itself providing it with a longer and healthier life span and at the same time creating an attractive presentation to the personal environment.

The hanging garden planter 100 may be easily transported in the horizontal position, in a display box, on shelves or in similar shipping material, to a retail environment or to the end user ready to be used in an upright position. The horizontal setting of the hanging garden planter allows for easy display on trays or shelves.

This new invention effectively creates a simplified, versatile, portable, self-contained hanging garden planter which requires a minimum of growing space, a minimum of parts and consumers require minimum knowledge, skills or effort to enjoy the benefits of an attractive garden atmosphere. The present invention also provides an easy self-measuring and self-distributing watering device which requires minimum maintenance, no mechanical parts, and is a simple solution for gardeners of any skill to easily maintain an attractive garden.

It is understood that the present invention may take many forms and embodiments as it is uniquely designed to be flexible and easily converted to many creative and novel applications. Accordingly, several variations may be made in the foregoing without departing from the spirit or the scope of the invention. For example, accommodating different materials, sizes and shapes of the sleeve 300, the water distributor 600 and the hanger apparatus 400; using it as an herbal, plant or flowering garden; enhancing its novelty through the use of different sleeve coverings, decorations or ornaments; converting it to a crafts or hobby kit to create a natural hanging garden planter, or replacing the water distributor and using filler material for decorative purposes using artificial plants or flowers; by creating a simpler system without the use of a water distributor; or by the addition of slots in the back of the sleeve to provide a hanging garden with plants growing circumferentially around the sleeve.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A hanging garden planter structure comprising:
a sleeve open on one end and sealed in the other;
a water distributor configured for positioning within said sleeve; and
a hanger apparatus connectable to said sleeve for suspending the sleeve.

2. The hanging garden planter of claim 1, wherein said sleeve is elongated and tubular-shaped, open at a first end and sealed at a second end, and having reinforced holes placed proximate to said first end to support a hanger apparatus.

3. The hanging garden planter of claim 2, wherein said sleeve contains openings or slots providing a display platform from which plants grow and extend outwardly.

4. The hanging garden planter of claim 2, wherein said sealed end of said sleeve may define at least one hole for drainage of excess water and/or nutrients.

5. The hanging garden planter of claim 1, wherein said water distributor is configured in the shape of a cone, open at a base end, closed at a tip end, and having orifices defined in the side of the cone.

6. The hanging garden planter of claim 5, wherein said orifices are configured for permitting water and/or nutrients to pass through and be substantially evenly distributed to the roots of plant positioned throughout the sleeve.

7. The hanging garden planter of claim 2, wherein said hanger apparatus is attached to the reinforced holes on said sleeve to suspend the hanging garden above a ground surface, and wherein said hanger apparatus is one of a continuous closed loop run through the reinforced holes on said sleeve, or a single length with each end attached individually to each reinforced hole on said sleeve.

8. The hanging garden planter of claim 1, wherein said hanging garden planter is versatile and can be changed for different uses such as accommodating different materials, sizes and shapes of the sleeve, the water distributor and the hanger apparatus; using it as an herbal, plant and/or flowering garden; enhancing its novelty through the use of different sleeve cover material and/or specialized ornaments; converting it to a crafts or hobby kit; using decorative artificial plants and/or flowers; or by the addition of openings or slots in the back of the sleeve to provide a hanging garden planter with plants placed circumferentially around the sleeve.

9. A hanging garden planter structure comprising:
a sleeve open on one end and sealed in the other;
a hanger apparatus connectable to said sleeve for suspending the sleeve.

10. The hanging garden planter of claim 9, wherein said sleeve is elongated and tubular-shaped, open at a first end and sealed at a second end, and having reinforced holes placed proximate to said first end to support a hanger apparatus.

11. The hanging garden planter of claim 10, wherein said sleeve contains openings or slots providing a display platform from which plants grow and extend outwardly.

12. The hanging garden planter of claim 10 wherein said sealed end of said sleeve may define at least one hole for drainage of excess water and/or nutrients.

13. The hanging garden planter of claim 10, wherein said hanger apparatus is attached to the reinforced holes on said sleeve to suspend the hanging garden above a ground surface, and wherein said hanger apparatus is one of a continuous closed loop run through the reinforced holes on said sleeve, or a single length with each end attached individually to each reinforced hole on said sleeve.

14. The hanging garden planter of claim 9 further comprising at least one of specialized ornaments, sleeve cover material, non-growing filler material, artificial plants and/or flowers adaptable for placement in connection with said sleeve.

15. The hanging garden planter of claim 9 further comprising at least one of specialized ornaments, sleeve cover material, plants, seeds, bulbs, and plant growing material adaptable for placement in connection with said sleeve.

16. The hanging garden planter of claim 9, wherein said hanging garden planter is versatile and can be changed for different uses such as accommodating different materials, sizes and shapes of the sleeve and the hanger apparatus; using it as an herbal, plant and/or flowering garden; converting it to a crafts or hobby kit; or by the addition of openings or slots in the back of the sleeve to provide a hanging garden planter with plants placed circumferentially around the sleeve.

17. A hanging garden planter structure kit comprising:
a sleeve open on one end and sealed in the other;
a water distributor configured for positioning within said sleeve; and
a hanger apparatus connectable to said sleeve for suspending the sleeve.

18. The kit of claim 17, wherein said hanging garden planter structure kit is versatile and can accommodate different materials, sizes and shapes of the sleeve, the water distributor and the hanger apparatus; using it as an herbal, plant and/or flowering garden; using decorative artificial plants and/or flowers; or by the addition of openings or slots in the back of the sleeve to provide a hanging garden planter with plants placed circumferentially around the sleeve.

19. The kit of claim 17 further comprising at least one of specialized ornaments, sleeve cover material, plants, seeds, bulbs, and plant growing material adaptable for placement in connection with said sleeve.

20. The kit of claim 17 wherein said sealed end of said sleeve may define at least one hole for drainage of excess water and/or nutrients.

21. A hanging garden planter structure kit comprising:
a sleeve open on one end and sealed in the other; and
a hanger apparatus connectable to said sleeve for suspending the sleeve.

22. The kit of claim 21, wherein said hanging garden planter structure kit is versatile and can accommodate different materials, sizes and shapes of the sleeve and the hanger apparatus; using it as an herbal, plant and/or flowering garden; using decorative artificial plants and/or flowers; or by the addition of openings or slots in the back of the sleeve to provide a hanging garden planter with plants placed circumferentially around the sleeve.

23. The kit of claim 21 further comprising at least one of specialized ornaments, sleeve cover material, non-growing filler material, artificial plants and/or flowers adaptable for placement in connection with said sleeve.

24. The kit of claim 21 further comprising at least one of specialized ornaments, sleeve cover material, plants, seeds, bulbs, and plant growing material adaptable for placement in connection with said sleeve.

25. The kit of claim 21 wherein said sealed end of said sleeve may define at least one hole for drainage of excess water and/or nutrients.

26. A method of fabricating a hanging garden planter, comprising the steps of:
filling a sleeve with plant growing material;
inserting a water distributor into the sleeve;
inserting plant roots, seeds or bulbs into the sleeve;
utilizing a watering system through the sleeve openings or slots; and
attaching a hanger apparatus to the sleeve.

27. The method of claim 26, further comprising the step of substantially filling the sleeve with plant growing material.

28. The method of claim 26, further comprising the step of inserting said water distributor substantially in the center of the plant growing material within said sleeve, wherein the water distributor is configured in the shape of a cone having a closed-tip end and an open end, the closed-tip end being directed towards a sealed end of said sleeve, the open end being flush with an open end of said sleeve, and the interior of said water distributor being void of plant growing material after insertion within said sleeve.

29. The method of claim 26, wherein the openings or slots perforated through said sleeve are the appropriate size to accommodate the plant roots, seeds or bulbs to be grown therein.

30. The method of claim 26, further comprising the step of inserting each of the plant's roots, seeds or bulbs through the slots and pressing them into the plant growing material in said sleeve.

31. The method of claim 26, further comprising the step of utilizing a watering system that disburses water and/or nutrients evenly through the sleeve openings or slots, ensuring an adequate water supply to each plant.

32. The method of claim 26, further comprising the step of attaching a suitably strong hanger apparatus to said sleeve through reinforced holes defined in said sleeve.

33. The method of claim 26, further comprising the step of attaching a descriptive plant care instruction tag to said hanging structure.

34. The method of claim 26, further comprising the step of attaching or inserting any number of decorative or novel elements to said hanging garden planter structure.

35. The method of claim 26, further comprising the step of suspending said hanging garden planter from a hanger on an above ground surface.

36. A method of fabricating a hanging garden planter, comprising the steps of:
filling a sleeve with plant growing material;
inserting plant roots, seeds or bulbs into the sleeve;
utilizing a watering system through the sleeve openings or slots; and
attaching a hanger apparatus to the sleeve.

37. The method of claim 36, further comprising the step of substantially filling the sleeve with plant growing material.

38. The method of claim 36, wherein the openings or slots perforated through said sleeve are the appropriate size to accommodate the plant roots, seeds or bulbs to be grown therein.

39. The method of claim 36, further comprising the step of inserting each of the plant's roots, seeds or bulbs through the slots and pressing them into the plant growing material in said sleeve.

40. The method of claim 36, further comprising the step of utilizing a watering system that disburses water and/or nutrients evenly through the sleeve openings or slots, ensuring an adequate water supply to each plant.

41. The method of claim 36, further comprising the step of attaching a suitably strong hanger apparatus to said sleeve through reinforced holes defined in said sleeve.

42. The method of claim 36, further comprising the step of attaching a descriptive plant care instruction tag to said hanging structure.

43. The method of claim 36, further comprising the step of attaching or inserting any number of decorative or novel elements to said hanging garden planter structure.

44. The method of claim 36, further comprising the step of suspending said hanging garden planter from a hanger on an above ground surface.

45. A method of fabricating a hanging garden planter, comprising the steps of:
filling a sleeve with non-growing filler material;
inserting artificial plants and/or flowers into the sleeve; and
attaching a hanger apparatus to the sleeve.

46. The method of claim 45, further comprising the step of substantially filling the sleeve with non-growing filler material.

47. The method of claim 45, wherein the openings or slots perforated through said sleeve are the appropriate size to accommodate the artificial plants and/or flowers to be displayed therein.

48. The method of claim 45, further comprising the step of inserting each of the artificial plants and/or flowers through the slots and pressing them into the non-growing filler material in said sleeve.

49. The method of claim 45, further comprising the step of attaching a suitably strong hanger apparatus to said sleeve through reinforced holes defined in said sleeve.

50. The method of claim 45, further comprising the step of attaching or inserting any number of decorative or novel elements to said hanging garden planter structure.

51. The method of claim 45, further comprising the step of suspending said hanging garden planter from a hanger on an above ground surface.
